(19) United States
(12) Patent Application Publication
(10) Pub. No.: US 2008/0031308 A1
(43) Pub. Date: Feb. 7, 2008

(54) Communication apparatus for parallel reception and accumulative reception

(75) Inventors: Ji Tae Kim, Yongin-si (KR); Jianliang Zheng, New York, NY (US); Myung Jong Lee, New York, NY (US)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/657,474

(22) Filed: Jan. 25, 2007

Related U.S. Application Data
(60) Provisional application No. 60/835,065, filed on Aug. 3, 2006.

(30) Foreign Application Priority Data
Sep. 28, 2006 (KR) 10-2006-0095146

(51) Int. Cl. H04B 1/00

(52) U.S. Cl. 375/142; 375/148; 375/150

(57) ABSTRACT

A communication apparatus includes an antenna which receives data frames from transmitters; at least one correlator, each of which is associated with a single identification code and detects a frame corresponding to the identification code from the data frames; and a reserved correlator which detects an acknowledge (ACK) frame from the transmitters corresponding to at least one correlator.

### CROSS-REFERENCE TO RELATED APPLICATIONS

This application claims priority under 35 U.S.C. §119(e) from U.S. Provisional Application No. 60/835,065, filed on Aug. 3, 2006, in the U.S. Patent and Trademark Office, and under 35 U.S.C. §119(a) from Korean Patent Application No. 10-2006-0095146, filed on Sep. 28, 2006, in the Korean Intellectual Property Office, the disclosures of both of which are hereby incorporated by reference in their entirety.

### BACKGROUND OF THE INVENTION

1. Field of the Invention

Methods and apparatuses consistent with the present invention relate to mobile communication, and more particularly, to a communication apparatus for embodying a parallel reception and effective retransmission mechanism.

2. Description of Related Art

A common spectrum multiple access with collision avoidance (CSMA-CA) scheme is generally used for an Institute of Electrical and Electronics Engineers (IEEE) 802.11 protocol, and requires each transmission to exclusively occupy a common channel. Also, since parallel reception is not supported in CSMS-CA, a hidden terminal problem may occur. A request-to-send (RTS)/clear-to-send (CTS) scheme is required to solve the hidden terminal problem. In a Code Division Multiple Access (CDMA) system, a plurality of nodes may simultaneously utilize the common channel by using spreading, but each transmission must have a unique source-destination pair. Specifically, even in the CDMA system, the parallel reception where a single node simultaneously receives data frames from a plurality of nodes is not supported.

Also, when a data frame is corrupted due to an error while the data frame is being transmitted, a retransmission of the entire data frame is required. Therefore, a communication apparatus for embodying a parallel reception and effective retransmission mechanism is required.

### SUMMARY OF THE INVENTION

An aspect of the present invention provides a communication apparatus which can simultaneously receive data frames from a plurality of nodes.

Another aspect of the present invention also provides a communication apparatus which can eliminate a control overhead such as a spreading code assignment in Code Division Multiple Access (CDMA) and request-to-send/clear-to-send (RTS/CTS) in a common spectrum multiple access with collision avoidance (CSMA-CA) scheme.

Another aspect of the present invention also provides a communication apparatus which can generate a highly reliable digital stream by using information about a frame where an error occurred during transmission, and thereby reduce the number of retransmissions.

According to another aspect of the present invention, there is provided a communication apparatus including: an antenna which receives a plurality of frames from a plurality of transmitters; at least one correlator which is associated with a single identification code, for example, a pseudo-noise (PN) code, respectively, and detects a frame corresponding to the identification code from the plurality of frames; and a reserved correlator which detects an acknowledge (ACK) frame from the plurality of transmitters corresponding to the at least one correlator.

According to another aspect of the present invention, there is provided a communication module further including: a controller which determines a transmitted frame corresponding to the ACK frame from the plurality of transmitters corresponding to at least one correlator by using a synchronization sequence included in the ACK frame; and a transmitting module which transmits the ACK frame in response to an ACK request frame when the frame is not received by at least one correlator.

According to still another aspect of the present invention, there is provided a communication apparatus including: a decision unit which determines a digital stream from a received frame; a flag generation unit which generates a reliability flag that designates a reliability of a digital value, which is determined with respect to each of a plurality of units which constitute the digital stream; and a controller which stores the digital stream and the reliability flag in a predetermined buffer when the frame corresponds to a first reception frame and includes an error.

### BRIEF DESCRIPTION OF THE DRAWINGS

The above and other aspects and advantages of the present invention will become apparent and more readily appreciated from the following detailed description of certain exemplary embodiments of the invention, taken in conjunction with the accompanying drawings in which:

FIG. 1 is a diagram illustrating an example of a parallel reception according to an exemplary embodiment of the present invention;

FIG. 2 is a block diagram illustrating a communication apparatus according to an exemplary embodiment of the present invention;

FIG. 3 is a diagram illustrating an example of accumulative reception according to an exemplary embodiment of the present invention; and

FIG. 4 is a diagram illustrating a retransmission mechanism according to an exemplary embodiment of the present invention.

### DETAILED DESCRIPTION OF EXEMPLARY EMBODIMENTS OF THE INVENTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

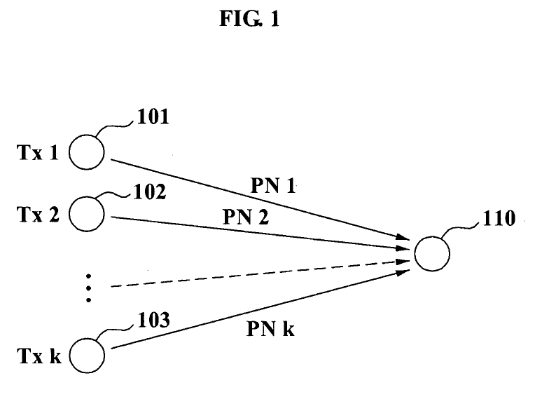

FIG. 1 is a diagram illustrating an example of a parallel reception according to an exemplary embodiment of the present invention.

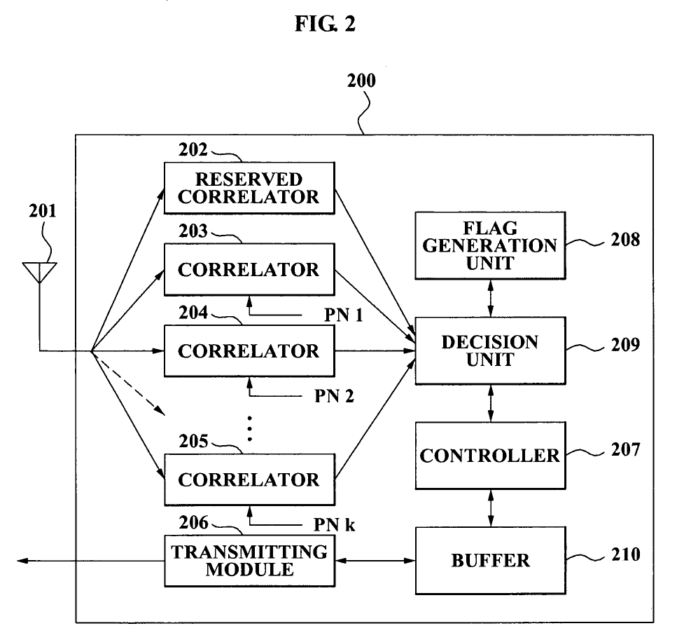

A communication apparatus 110 according to the present invention supports a parallel reception which receives data frames from a plurality of nodes 101, 102, and 103. In FIG. 1, each of the plurality of nodes 101, 102, and 103 spreads the data frame by using a pseudo-noise (PN) code PN1 through PNk which is assigned to a transmitter-receiver pair. In a conventional Code Division Multiplexing Access (CDMA) system, a transmitter utilizes a PN code which is determined depending upon a destination of a data frame that the transmitter desires to transmit. Specifically, from a viewpoint of a receiver, only a single PN code is assigned, and the receiver despreads the received data frame by using the PN code. However, in the present invention, the transmitter utilizes the PN code, which is assigned to the transmitter-receiver pair, to support the parallel reception. Specifically, the transmitter utilizes a PN code which is assigned to a pair of (1) transmitter and (2) correlator in a receiver. A correlator in a receiver will be described later with reference to FIG. 2. As described above, each of the plurality of transmitters, i.e., the nodes 101, 102, and 103, transmits a data frame by using an identical receiver, i.e., the communication apparatus 110, as a destination. However, each of the transmitters 101, 102, and 103 utilizes a different PN code for spreading.

Also, in the present invention, a PN code, which is assigned to a pair of the transmitter and the correlator, is unchanged while a network is being constructed. Specifically, every time each of the transmitters 101, 102, and 103 transmits a data frame, a new PN code is not utilized. While the transmitters 101, 102, and 103, and the receiver 110 construct a network, an identical PN code is utilized. Accordingly, an overhead, which is generated by assigning a new PN code for each transmission, may be eliminated. When peripheral devices construct a Personal Area Network (PAN), the peripheral devices communicate with each other by using a unique PN code which is assigned to the transmitter-receiver pair. Also, the unique PN code is unchanged until a configuration of the PAN is changed, which is referred to as a “single PN code approach.”

FIG. 2 is a block diagram illustrating a communication apparatus 200 according to an exemplary embodiment of the present invention.

The communication apparatus 200 includes an antenna 201, a reserved correlator 202, at least one correlator, shown in FIG. 2 as correlators 203 through 205, a transmitting module 206, a controller 207, a flag generation unit 208, a decision unit 209, and a buffer 210.

The antenna 201 receives a plurality of frames from a plurality of transmitters. In this instance, the received frame corresponds to a spread signal by using a PN code which is assigned to a transmitter-receiver pair.

Each of the correlators 203, 204, and 205 detects a frame corresponding to each of the correlators 203, 204, and 205, from the plurality of frames. As illustrated in FIG. 2, each of the correlators 203, 204, and 205 is associated with a single identification code, respectively. In the present exemplary embodiment, the PN code is utilized for the identification code. The correlator 203 is associated with a PN 1, the correlator 204 is associated with a PN 2, and the correlator 205 is associated with a PN k. In this instance, the PN code is assigned to a transmitter-correlator pair. Also, an identical value of the PN code is utilized with respect to the transmitter-correlator pair during a configuration of a network. A plurality of frames, which is simultaneously spread from a plurality of transmitters, is transferred to the plurality of correlators 203, 204, and 205. Each of the correlators 203, 204, and 205 despreads the received frame by using a PN code associated with each of the correlators 203, 204, and 205, and thereby detects a corresponding frame. As described above, a plurality of PN codes corresponds to a single communication apparatus 200.

The reserved correlator 202 performs two functions.

In one function, the reserved correlator 202 detects an ACK frame from a plurality of transmitters which correspond to the correlators 203, 204, and 205. Since the ACK frame may be transmitted without spreading depending upon a communication system, the reserved correlator 202 is utilized to receive the ACK frame in addition to the correlators 203, 204, and 205 used for despreading the received data frames. Also, according to the present invention, the ACK frame and a data frame may be simultaneously received.

When the communication apparatus 200 transmits a frame via the transmitting module 206 and then waits for an ACK frame, the reserved correlator 202 is converted into an ACK receive mode, and waits for the ACK frame in the ACK receive mode. According to the present invention, a plurality of communication apparatuses substantially transmit/receive frames at the same time. Accordingly, the reserved correlator 202 is required to determine which frame of the reserved correlator 202 the received ACK frame corresponds to. In this instance, according to the present invention, when transmitting a frame, a transmitter includes a randomly selected synchronization sequence in the frame and thereby transmits. Also, a receiver receives the frame and transmits an ACK frame with the synchronization sequence when transmitting the ACK frame. The transmitter, which receives the ACK frame, may determine which frame of the transmitter the ACK frame corresponds to, by using the synchronization sequence which is included in the ACK frame.

In another function, when the communication apparatus 200 is not waiting for an ACK frame, the reserved correlator 202 searches for an ongoing reception frame to determine whether the ongoing reception frame exists. According to the present invention, the reserved correlator 202 does not search the entire ongoing reception frame but only searches a frame head of the ongoing reception frame. Specifically, whether the ongoing reception frame exists may be determined with only the frame head. In the present invention, although a frame to transmit via the transmitting module 206 exists, the communication apparatus 200 delays a transmission of the frame when at least one of the correlators 203, 204, and 205 receives a frame. Specifically, the ongoing reception frame is more important than transmission of the ACK frame. Thus, although an ACK frame to transmit exists, the transmission of the ACK frame is delayed when at least one of the correlators 203, 204, and 205 receives a frame.

However, as a result of searching for an ongoing reception frame, when none of the correlators 203, 204, and 205 receives a frame, the controller 207 transmits the frame to transmit via the transmitting module 206. As an example, when an ACK frame is required to be transmitted in response to an ACK request frame, and also none of the correlators 203, 204, and 205 receives a frame, the transmitting module 206 transmits the ACK frame.

Hereinafter, an acknowledgement mechanism according to the present invention will be described in detail.

When none of the correlators 203, 204, and 205 are receiving a frame, an ACK frame is transmitted to a transmitter of a frame requesting the ACK frame as soon as the frame is received. However, when at least one of the correlators 203, 204, and 205 is receiving an ongoing reception frame, acknowledgement is delayed. According to the present invention, there is a maximum allowed delay time, MaxACKDelay, for acknowledgement. When the frame requesting the ACK frame is received, the controller 207 determines whether an ongoing frame is being received. When the ongoing frame is being received, the controller 207 determines whether the ongoing frame being received will be completed within the MaxACKDelay. When the ongoing frame being received may be completed within the MaxACKDelay, the controller 207 delays the transmission of the ACK frame. However, when the ongoing frame being received may not be completed within the MaxACKDelay, the controller 207 terminates the reception of the ongoing frame and transmits the ACK frame. As a result of searching for an ongoing reception frame, when it is determined that none of the correlators 203, 204, and 205 is receiving a frame and a plurality of ACK frames are stored in the buffer 210, all the plurality of ACK frames are transmitted.

The transmitting module 206 transmits the requested frame. In the present invention, devices of a single network communicate with each other substantially at the same time. Also, a single device simultaneously receives frames from a plurality of devices. Thus, after a transmission of a frame, a synchronization sequence is utilized in identifying an ACK frame for the frame. Specifically, the transmitting module 206 transmits the requested frame with the synchronization sequence. In this instance, when a method of increasing a synchronization sequence by one is adopted, synchronization sequences from different devices may match and thereby a collision may incur. Thus, in the present invention, a randomly selected synchronization sequence is included in the requested frame. Also, when transmitting an ACK frame in correspondence to a received frame, the transmitting module 206 includes the synchronization sequence, which is included in the received frame, in the ACK frame and thereby transmits.

In this instance, even when ACK frames are received from a plurality of transmitters, the controller 207 may determine a transmission frame corresponding to the ACK frame by using the synchronization frame which is included in the ACK frame. Also, when the received frame corresponds to a first reception frame and also includes an error, the controller 207 stores a digital stream and a reliability flag in the buffer 210.

A frame despread by each of the correlators 204, 205, and 206 is transferred to the decision unit 209.

The decision unit 209 determines a digital stream from the received frame. In this instance, the digital stream is formed of a binary value.

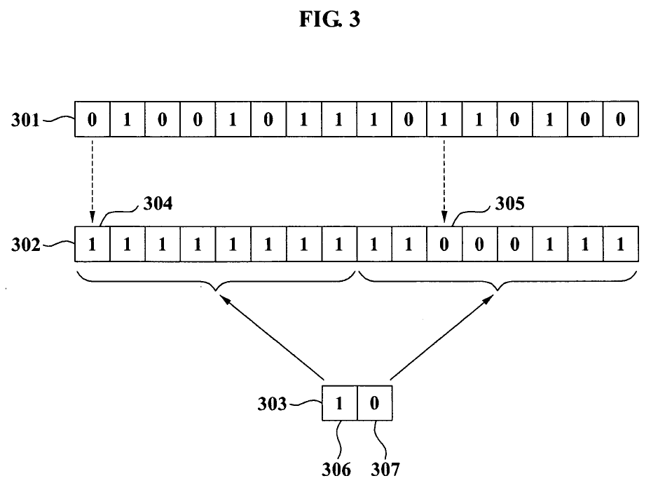

The flag generation unit 208 generates a reliability flag that designates a reliability of a digital value, which is determined with respect to each of a plurality of units which constitutes the digital stream. In this instance, the unit may be a bit or a byte. Operations of the decision unit 209 and the flag generation unit 208 will be described in detail with reference to FIG. 3.

The buffer 210 stores a digital stream where an error occured, a reliability flag with respect to the digital stream, a combined digital stream, and a combined reliability flag, for accumulative reception of the present invention. Also, the buffer 210 is utilized to temporarily store a frame to be transmitted.

FIG. 3 is a diagram illustrating an accumulative reception according to an exemplary embodiment of the present invention. Operations of the decision unit 209 and the flag generation unit 208 of FIG. 2 will be described with reference to FIG. 3.

A digital stream 301 is determined by the decision unit 209. A value determined from a received frame corresponds to a digital stream of “01001 . . . ”. A reliability flag 302 designates a reliability of a digital value which is determined with respect to each of a plurality of units which constitute the digital stream 301. In the present exemplary embodiment, the unit is a bit. Specifically, the reliability flag 302 expresses a reliability of a digital value, “0” or “1” , which is determined with respect to each bit of the digital stream 301. In the present exemplary embodiment, a first bit of the digital stream 301 is determined to be “0”. Also, it is highly probable that the value may have “0”. Thus, a value 304 of the reliability flag 302 corresponding to the first bit “0” is assigned with “1”. Also, an eleventh bit of the digitals stream 301 is determined to be “1”. However, it is less probable that the value may have “1” and thus, a value 305 of the reliability flag 302 corresponding to the eleventh bit is assigned with “0”. In the present exemplary embodiment, the reliability flag 302 expresses the reliability of the digital value, which is determined with respect to each bit constituting the digital stream 301, as a binary value, “0” or “1”.

As an example, in the case of +5(V) with respect to a received frame, the decision unit 209 may determine the reliability as “1”. Also, in the case of −5(V), the decision unit 209 may determine the reliability as “0”. In this case, a substantially received value may have various types of values, in addition to +5(V) and −5(V). In this instance, the decision unit 209 determines voltages greater than 0(V) as “1”, and determines voltages less than 0(V) as “0”. Also, when the received values is greater than +2.5(V) or less than −2.5(V), the flag generation unit 208 determines that the digital value, which is determined by the decision unit 209, has a high reliability, and thus assigns “1” of reliability flag value to a corresponding bit. Also, when the received value is between +2.5(V) and −2.5(V), the flag generation unit 208 determines that the digital value determined by the decision unit 209 as less reliable, and thus assigns a “0” to a corresponding bit of the reliability flag. As described above, the determined bit stream does not have only two values, “0” and “1”. Specifically, the determined bit stream has four values, highly reliable “0”, less reliable “0”, highly reliable “1”, and less reliable “1”. Determining more than 3 values from the received frame is referred to as an m-value decision.

According to an exemplary embodiment of the present invention, the controller 207 transmits information about the units of the digital stream 301, which are determined to have no reliability, to the transmitter which has transmitted the digital stream 301. In this instance, the controller 207 may transmit the information to the transmitter by transmitting the reliability flag 302 to the transmitter.

According to another exemplary embodiment of the present invention, the controller 207 groups information about units of the digital stream 301, which are determined to have no reliability, and transmits the grouped information to the transmitter which has transmitted the digital stream 301. In FIG. 3, the reliability flag 302 indicates a reliability with respect to each bit of the digital stream 301. A grouped reliability flag 303 designates a reliability of grouped blocks by grouping values of the reliability flag 302 according to a predetermined block unit. In FIG. 3, the grouped reliability flag 302 designates 8 bits, i.e., 1 byte, of the reliability flag 302 as a grouped value. Values corresponding to 1^{st} to 8^{th} bits of the digital stream 301 are all highly reliable values. Thus, all values of the reliability flag 302 corresponding thereto become “1”. Since all the reliabilities of corresponding values of 8 bits of the digital stream 301 are “1”, a corresponding field 306 of the grouped reliability flag 303 has a value of “1”. However, some values corresponding to 9^{th} to 16^{th} bits of the digital stream 301 are less reliable values. Accordingly, values of the reliability flag 302 corresponding thereto become “1” or “0”. Since all the reliabilities of corresponding values of 8 bits of the digital stream 301 are not “1”, a corresponding field 307 of the grouped reliability flag 303 has a value of “0”. As described above, since information about the reliability of the digital stream 301 is transmitted to a counterpart according to a predetermined grouped unit, not a bit unit, overhead, which may occur during the transmission of the information, may be reduced.

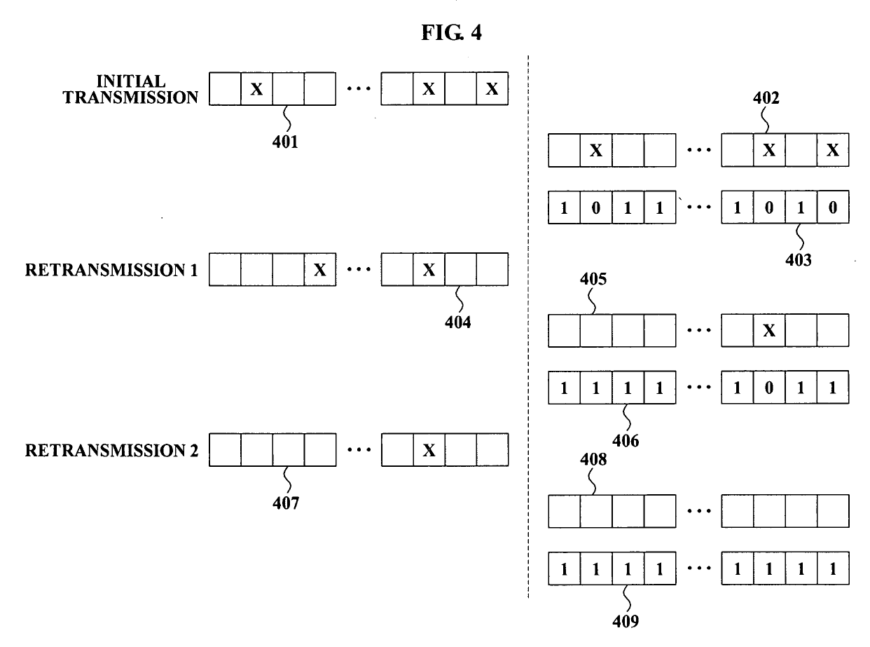

FIG. 4 is a diagram illustrating a retransmission mechanism according to an exemplary embodiment of the present invention. An accumulative reception which determines a digital stream of a single frame from repeatedly received frames with respect to the single frame will be described with reference to FIG. 4.

The communication apparatus 200 illustrated in FIG. 2 of the present invention receives a frame 401 from a transmitter. In FIG. 4, a frame marked with “x” designates that a value of a corresponding location has a low reliability due to effects of a communication error, and the like. The frame 401 corresponds to a first reception frame of the communication apparatus 200 with respect to a corresponding frame. The decision unit 209 determines the digital stream 402 from the received frame 401. The flag generation unit 208 generates a reliability flag 403 designating a reliability of a bit value which is determined with respect to each bit of a digital stream 402.

When the received frame 401 corresponds to a first reception frame and also includes an error, i.e., includes data which is determined to have a low reliability, the controller 207 stores the digital frame 402, which is generated from the frame 401, and the reliability flag 403 in the buffer 210. A digital stream, which is stored in the buffer 210 in association with the accumulative reception, is referred to as a combined digital stream. Also, a reliability flag, which is stored in the buffer 210 in association with the accumulative reception, is referred to as a combined reliability flag. Also, the controller 207 transmits a negative acknowledge (NAK) frame to the transmitter via the transmitting module 206 and thereby requests a retransmission of the frame 401.

As described above with FIG. 3, when requesting a retransmission, the controller 207 may transmit information about units of the digital stream 402, which are determined to have no reliability, to a transmitter of the received frame 401. In this instance, the units, which are determined to have no reliability, may be a bit or a byte, and also may be a grouped block unit. In this case, the transmitter may partially retransmit only the units, which are determined to have no reliability, i.e., the transmitter does not transmit the entire frame 401.

In response to the retransmission request of the communication apparatus 200, the transmitter retransmits a frame 404. In this instance, the frame 404 corresponds to a retransmission frame of the frame 401. Also, the retransmission frame 404 may include an error in some bits during transmission.

Since the received frame 404 does not correspond to a first reception frame, the controller 207 generates a second combined digital stream 405 and a second combined reliability flag 406 based on 1) a digital stream and a reliability flag which are determined from the received frame 404, and 2) a first combined digital stream 402 and a reliability flag 403 which are stored in the buffer 210. More specifically, the controller 207 combines the units, for example, bits of the first combined digital stream 402, which are determined to have a reliability based on the first combined reliability flag 403, with the units, for example, bits of the digital stream of the frame 404, which are determined to have a reliability based on the reliability flag determined from the received frame 404, and thereby generates the second combined digital stream 405. Specifically, the controller 207 generates a new combined digital stream by utilizing values which are determined to have a higher reliability with respect to any one of the combined digital stream, which is stored in the buffer 210, and a currently received digital stream. Also, the controller 207 determines that the units of any one of the first combined reliability flag 403 and the reliability flag determined from the frame 404, which are determined to have a reliability, actually have a reliability, and thereby generates the second combined reliability flag 406. Specifically, in the transmission of the initial frame 401, an error was included in three units. Also, in the retransmission frame 404, an error was included in two units. However, the combined digital stream 405 which includes an error in only a single unit is generated by using the above values.

When an error is not included in the generated combined digital stream 405, the controller 207 does not request the transmitter to retransmit a corresponding frame even when the retransmission frame 404 includes an error. In this instance, a combined digital stream is utilized.

However, when an error is included in the generated combined digital stream 405, the controller 207 stores the second combined data stream 405 and the second combined reliability flag 406 in the buffer 210. Also, the controller 207 transmits a NAK frame to a transmitter of a received frame via the transmitting module 206, and thereby requests a retransmission of the corresponding frame.

When requesting the retransmission, the controller 207 may transmit information about the units of the digital stream, which are determined to have no reliability based on the second combined reliability flag 406, to the transmitter of the received frame 404.

In response to a retransmission request of the communication apparatus 200, the transmitter performs a second retransmission of a frame 407. In this instance, the frame 407 corresponds to a second retransmission frame of the initial frame 401. Also, the retransmission frame 407 may include an error in some bits during transmission.

Since the received frame 407 does not correspond to a first reception frame, the controller 207 generates a second combined digital stream 408 and a second combined reliability flag 409, based on 1) a digital stream and a reliability flag which are determined from the received frame 407, and 2) the first combined digital stream 405 and the first combined reliability flag 406 which are stored in the buffer 210.

In the present exemplary embodiment, the generated second combined digital stream 408 includes no error. Specifically, bits which constitute the generated second combined digital stream 408 have highly reliable values. Thus, although the retransmission frame 407 includes an error, the controller 207 does not request the transmitter for retransmission of a corresponding frame, and utilizes the second combined digital stream 408.

According to the present invention, there is provided a communication apparatus which can simultaneously receive data frames from a plurality of nodes. Also, according to the present invention, a correlator is separately installed to receive an ACK frame. Thus, even in an environment where a plurality of communication apparatuses simultaneously transmit/receive data, an effective communication is enabled.

Also, according to the present invention, a single PN code is utilized. Thus, a control overhead, such as a request-to-send (RTS)/clear-to-send (CTS) in a common spectrum multiple access with collision avoidance (CSMA-CA) scheme and a spreading code assignment in CDMA, may be eliminated.

Also, according to the present invention, a problem of transmitting a frame to a transmitting node may be solved by providing an effective searching method.

Also, according to the present invention, a highly reliable digital stream is generated by using information about a frame where an error occurred during transmission. Thus, a number of retransmissions may be reduced. Also, when requesting a retransmission, information about a damaged part of a frame is transmitted to a source. Thus, a portion of the frame rather than the entire frame may be transmitted. Specifically, a communication bandwidth may be effectively utilized.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A communication apparatus comprising:
an antenna which receives a plurality of frames from a plurality of transmitters;
at least one correlator, each of which is associated with a single identification code respectively, and detects a frame corresponding to the identification code from the plurality of frames; and
a reserved correlator which detects an acknowledge (ACK) frame from the plurality of transmitters corresponding to the at least one correlator.

2. The communication apparatus of claim 1, wherein one of the at least one correlator and one of the plurality of transmitters comprises a transmitter-receiver pair, and the identification code is unchanged with respect to the transmitter-receiver pair while a network is being constructed.

3. The communication apparatus of claim 1, wherein the communication apparatus and one of the plurality of transmitters comprise a transmitter-receiver pair, and the identification code is assigned to the transmitter-receiver pair.

4. The communication apparatus of claim 1, wherein the identification code corresponds to a pseudo-noise (PN) code.

5. The communication apparatus of claim 1, further comprising:
a controller which determines a transmitted frame corresponding to the ACK frame from the plurality of transmitters corresponding to the at least one correlator by using a synchronization sequence included in the ACK frame.

6. The communication apparatus of claim 1, further comprising:
a transmitting module which transmits the ACK frame in response to an ACK request frame when none of the at least one correlator receives the frame.

7. The communication apparatus of claim 6, wherein the transmitting module delays a transmission of the ACK frame when the at least one correlator receives the frame.

8. The communication apparatus of claim 6, wherein the transmitting module includes a randomly selected synchronization sequence in a requested frame, and thereby transmits the randomly selected synchronization sequence.

9. The communication apparatus of claim 1, wherein the reserved correlator searches for an ongoing reception frame when the ACK frame is not expected.

10. The communication apparatus of claim 9, wherein the reserved correlator searches only a frame head of the ongoing reception frame.

11. A communication apparatus comprising:
a decision unit which determines a digital stream from a received frame;
a flag generation unit which generates a reliability flag that designates a reliability of a digital value, which is determined with respect to each of a plurality of units which constitute the digital stream; and
a controller which stores the digital stream and the reliability flag in a predetermined buffer when the frame corresponds to a first reception frame and includes an error.

12. The communication apparatus of claim 11, wherein the reliability flag designates the reliability of the digital value, which is determined with respect to each of the plurality of units which constitute the digital stream, as a binary value.

13. The communication apparatus of claim 11, wherein the controller generates a second combined digital stream and a second combined reliability flag based on a first combined digital stream and a first combined reliability flag, the digital stream, and the reliability flag when the frame does not correspond to the first reception frame.

14. The communication apparatus of claim 13, wherein the controller generates the second combined digital stream by combining units of the first combined digital stream, which are determined to have the reliability based on the first combined reliability flag, with units of the digital stream, which are determined to have the reliability based on the reliability flag.

15. The communication apparatus of claim 13, wherein the controller determines that units of any one of the first combined reliability flag and the reliability flag have the reliability, and thereby generates the second combined reliability flag.

16. The communication apparatus of claim 13, wherein the controller stores the second combined digital stream and the second reliability flag in the buffer when an error is included in the second combined digital stream.

17. The communication apparatus of claim 16, wherein the controller transmits a negative acknowledge (NAK) frame to a transmitter of the received frame when the error is included in the second combined digital stream.

18. The communication apparatus of claim 16, wherein the controller transmits information about units of the digital stream, which are determined to have no reliability based on the second combined reliability flag, to the transmitter of the received frame when the error is included in the second combined digital stream.

19. The communication apparatus of claim 18, wherein the controller groups information about the units of the digital stream, which are determined to have no reliability, and transmits the grouped information.
